(19) United States
(12) Patent Application Publication
(10) Pub. No.: US 2025/0114888 A1
(43) Pub. Date: Apr. 10, 2025

(54) CLAMPING COMPONENT AND TOOL HOLDER

(71) Applicant: Albrecht Präzision GmbH & Co. KG, Wernau (DE)

(72) Inventors: Martin SCHMIDEDER, Leinfelden-Echterdingen (DE); Joel AMMERSDÖRFER, Ebersbach (DE)

(21) Appl. No.: 18/729,433

(22) PCT Filed: Jan. 17, 2023
(86) PCT No.: PCT/EP2023/051026

§ 371 Date: Jul. 16, 2024

(30) Foreign Application Priority Data
Jan. 17, 2022 (DE) 102022100972.6

(51) Int. Cl. B23Q 1/52

(52) U.S. Cl. CPC B23Q 1/52

(57) ABSTRACT

The clamping component according to the present disclosure has a locking pin movable between the first and the second position, which is provided with a tool retaining area formed between the ends of the locking pin. In the first position, the tool retaining area protrudes into a tool receiving bore of the clamping component, while in the second position, the locking pin does not protrude into the tool receiving bore. The locking pin is always attached to the clamping component in both the first and the second position, which makes the improved withdrawal protection particularly easy to use and ensures that it cannot be lost. The locking pin can be moved (steplessly) between the first and second position, whereby the tool retaining area of the locking pin in the first position prevents the tool from being drawn out of and rotated out of the tool receiving bore.

### CROSS REFERENCE TO RELATED APPLICATIONS

This application is a National Stage of PCT Application No. PCT/EP2023/051026 filed on Jan. 17, 2023, which claims priority to German Patent Application No. 10 2022 100 972.6 filed on Jan. 17, 2022, the contents each of which are incorporated herein by reference thereto.

### TECHNICAL FIELD

The present disclosure relates to a clamping component of a tool holder for clamping tools, in particular tools for machining workpieces with rotating tools, and to a toolholder with such a clamping component.

### BACKGROUND

Tools, such as drills, milling cutters and the like, are typically held by a toolholder for machining a workpiece. To ensure that the workpiece is machined as precisely as possible, it is of great importance that the tool is clamped torsion-resistant and pull-out-resistant. On the machine side, the toolholders are typically provided with an interface that serves to connect them to a machine spindle.

For example, such toolholders are equipped with the tools in a so-called tool magazine and are inserted into and removed from the work spindle of a processing machine by means of a tool changing device.

For the secure retention of a tool held in a toolholder, toolholders with collets are typically employed, which are suitable for receiving tool shanks of varying sizes and/or shapes. Shrink fit chucks are also known from the prior art, e.g., JP 2002-355727 A, in which the tool receiving bore has a slightly smaller internal diameter than the external diameter of a tool shank, for example an internal diameter that is 3 μm to 7 μm less. In order for the shrink-fit chuck to receive a tool, it must first be heated. This expansion of the tool-receiving bore allows the internal diameter to exceed the external diameter of the tool shank. Following the insertion of the tool, the chuck must then cool down before the tool is ready for use.

During the machining of a workpiece with a tool held in a toolholder, forces and torques act on the tool. These forces and/or torques, particularly in combination with vibrations, can result in the tool gradually working its way out of the toolholder bore in the axial direction. This effect is also known as (axial) pullout of the tool from the toolholder.

Various approaches for securing the tool against axial pullout from the tool receiving bore are known from the prior art.

DE 10 2015 122 763 A1 describes, for example, a toolholder arrangement in which a toolholder has several displaceable locking elements that are arranged in a radial direction to the collet and engaged in a recess formed in the collet. The recess is adapted to the locking elements. This only prevents axial movement of the collet relative to the toolholder, but not axial movement of the tool relative to the toolholder.

DE 20 2007 019 560 U1 describes a chuck with a pullout protection device, in which locking elements are in engagement with a locking groove provided in the tool shank of the tool, when a tool is arranged in the tool receiving bore. The locking elements are arranged radially with respect to the tool receiving bore of the chuck, with the locking grooves having a course that describes a sectional straight and/or curved cylinder surface path on the lateral surface of the tool shank. This chuck necessitates a tool shank that has been prepared in a particular manner.

JP 2002-355 727 A describes a shrink fit chuck in which a cylindrical locking pin can be screwed into a bore in the shrink fit chuck after heating the shrink fit chuck, inserting the tool into a tool receiving bore and cooling the tool. The bore of the locking pin intersects the tool mounting bore of the shrink fit chuck in such a way that a lateral surface of the locking pin rests against a surface of a groove in the tool shank when a tool is arranged in the tool receiving bore, so that the locking pin prevents the tool from rotating relative to the shrink fit chuck during workpiece machining. When changing the tool, however, the locking pin must be released and at least partially removed from the bore, which means that there is a risk of the locking pin being lost in practice.

DE 20 2015 105 500 U1, DE 10 2014 101 122 B3 and DE 10 2011 106 421 B3 describe locking mechanisms for hydraulic chucks in which a locking pin can be inserted into a bore in a clamping sleeve. The clamping sleeve also has a tool receiving hole. The bore of the locking pin in the clamping sleeve intersects the tool receiving bore of the clamping sleeve in such a way that a lateral surface of the locking pin rests against a surface of a groove in the tool shank of a tool arranged in the tool receiving bore. In practice, however, there is also a risk that the locking pin will be lost when the tool is changed.

In U.S. Pat. No. 3,425,705, a chuck is described which has several segments, one of the segments being provided with an opening arranged radially to the tool receiving bore, in which a cylindrical locking pin is arranged displaceable in the radial direction. The movement of the locking pin is limited by a retaining pin which projects into an opening in the locking pin which is larger than the diameter of the retaining pin. The radially arranged locking pin has two ends, wherein the end of the locking pin that is further inwards rests against a slanted side surface of a tool groove of the tool inserted into the tool receiving bore and the end of the locking pin that is further outwards rests against an inner wall of the toolholder. When a force acts on the tool in the direction of pullout during tool machining, the locking pin is pressed radially outwards against the toolholder. The support of the radial locking pin may result in a compromise of the distribution of forces and thus the concentricity of the tool.

### BRIEF SUMMARY

Based on this, the problem solved by the present disclosure is to provide a clamping component and a toolholder which enable reliable and, in practice, robust securing against axial pullout (withdrawal) of a tool from a tool receiving bore of the clamping component.

This problem is solved with the clamping component for a toolholder for clamping tools, preferably tools for machining workpieces with rotating tools, including: a base body, which has an outer surface and a cylindrical tool receiving bore, arranged concentrically to the outer surface, with a locking pin bore, which is arranges tangentially in the base body and defined an overlapping area by overlapping with the tool receiving bore, a moveable locking pin, with a first end and a second end and a tool retaining area, arranged between the first end and the second end, wherein a first position of the locking pin, defined by a first stop means, the tool retaining area is arranged in the overlapping area, wherein the locking pin is held at both ends within the locking pin bore of the clamping component on both sides of the overlapping area, and wherein, in a second position of the locking pin, defined by a second stop means, the first end is arranged outside and the second end is arranged at least partially inside the locking pin bore of the clamping component, but outside of the overlapping area.

The clamping component according to the present disclosure has a base body with an outer surface and a cylindrical tool shank receiving bore arranged concentrically to the outer surface. The outer surface of the base body may be interrupted by recesses such as slots, balancing holes or the like. The base body is provided with a locking pin bore which is arranged tangentially in the base body and defines an overlapping area by overlapping with the tool shank receiving bore.

The clamping component also has a movable locking pin with a first end, a second end and a tool retaining area arranged between both ends. Preferably, the locking pin bore is arranged in such a way that a center in axis of the locking pin meets the tool retaining bore at least substantially, tangentially. In particular, the locking pin is continuously displaceable and the locking pin bore cannot be rotated. The clamping component can preferably be a collet chuck or a clamping sleeve, for example, for a hydraulic chuck. If the clamping component is configured as a collet chuck, the base body of the collet chuck preferably has a conical outer surface.

In a first position of the locking pin defined by a first stop means, the tool retaining area is arranged in the overlapping area. The locking pin is held at both ends within the locking pin bore of the clamping component on both sides of the overlapping area. All forces emanating from the locking pin during operation are absorbed by the clamping component and not transferred to the toolholder body. This is beneficial for the concentricity of the tool. In a second position of the locking pin defined by a second stop means, the first end is arranged outside and the second end is arranged at least partially inside the locking pin bore of the clamping component, but outside the overlapping area.

The locking pin is preferably an element whose length is greater than its width orthogonal to the center axis, wherein the end portions of the locking pin are connected by an elongated body. The ends of the locking pin are the two end regions of the locking pin between which the tool retaining area is arranged. A locking pin may, for example, be formed as a general cylinder, which may have an at least essential elliptical, circular, rectangular or polygonal base. In addition, the locking pin may, for example, be conical in its entirety or in sections, such as, e.g., to be held without play in its locked position.

The tool stop means may, for example, be path limiting means, such as stop surfaces or elements having stop surfaces that limit the movement stroke of the locking pin.

This makes it possible to provide a locking means that prevents axial pullout (withdrawal) of a tool inserted into the tool receiving bore of the clamping component, wherein it is also not possible to move the locking pin beyond the second position, for example, when changing the tool. The locking means is thus always attached to the clamping component and therefore cannot be lost.

A special aspect of the clamping component according to the present disclosure lies in the particularly simple the handling of the improved pullout (withdrawal) protection. The locking pin can be moved (steplessly) between the first and the second position, wherein the tool retaining area of the locking pin in the first position prevents the tool from being pulled out (drawn out) and twisted out of the tool receiving bore. In the second position of the locking pin, it is possible to pull the tool out of the tool receiving bore, as the locking pin is located outside the overlapping area. In this case, the locking pin is always arranged at the clamping component, i.e. it is held securely. Removal of the locking pin from the locking pin bore is prevented by the second stop means. This means, that the locking pin cannot be removed from the clamping component when changing a tool, thus minimizing the risk of losing the locking pin during the changing process. This is particularly advantageous in practical use.

Preferably, the locking pin has a recess along the center axis of the locking pin which defines at least one surface along which the second stop means slides when the locking pin is moved, thereby enabling the locking pin to be moved at least between the first and second position.

In particular, the surface of the recess can be a flat surface that runs parallel to this center axis of the locking pin. Alternatively and/or additionally, the recess can have a convex shaped surface with which extends parallel to the center axis of the locking pin and is preferably adapted to a concave shaped surface of the second stop means. This allows the locking pin to be displaced along the center axis of the locking pin, but prevents the pin from rotating.

It is preferred that the recess is arranged on a side of the locking pin facing away from the tool retaining area of the locking pin, whereby the tool retaining area has an area as large as possible against which at least one shank groove of the tool can bear. In addition, such an arrangement of the recess of the locking pin is advantageous with regard to the forces that can act on the locking pin in the pullout (withdrawal) direction during workpiece machining. The shank groove of the tool may, for example, be shaped as a so-called Weldon groove or Weldon mounting. A tool can also have several shank grooves, for example, two or three shank grooves in different axial positions of the tool shank, wherein at least one of the several shank grooves is located in the overlapping area when the tool shank is inserted into the receiving bore of the tool chuck.

Preferably, the recess extends from the first end of the locking pin to a first stop surface formed in the locking pin. The first stop surface may, preferably, be arranged at least substantially orthogonal to the center axis of the locking pin. In particular, the first stop surface is in contact with a second stop surface formed in the second stop means when the locking pin is in the second position. This limits the movement stroke of the locking pin in the pushout direction so that the locking pin is prevented from being pushed out of their locking pin bore beyond the second position.

It is preferred that a third stop surface is formed at the second end of the locking pin, which rests against the first stop means when the locking pin is in the first position. This results in the movement stroke of the locking pin being limited in the direction of insertion of the locking pin into the locking pin bore. The locking pin may thus be brought as easily as possible into the first position, in which the tool retaining area of the locking pin prevents the tool from being pulled out and twisted.

In particular, the first stop means is a fourth stop surface formed at an end region of the locking bore against which the second end of the locking pin rests when the locking pin is in the first position.

Preferably, a pushout bore, through which the locking pin can be pushed out, adjoins the end region of the locking pin bore. The locking pin can be pushed out, for example, with a tool pin at adapted to the inner diameter of the pushout bore.

It is preferred that the second stop means is pressed and/or glued into a stop means opening adapted to the second stop means in the base body of the clamping component. By pressing and/or gluing the second stop means into position, slipping of the second stop means can be prevented.

In particular, the second stop means is designed as one of the following elements: a feather key, a locking pin, a slotted link or a stop ball.

Preferably, the second end of the locking pin has a convex surface which is adapted to the curvature of the inner wall of the tool receiving bore when the locking position is in the second position. Thus, the second end of the locking pin remains arranged outside the overlapping area when the locking pin is in the second position, whereby a particularly compact design of the locking mechanism is made possible.

Preferably, the tool retaining area of the locking pin in the overlapping area can be brought into engagement with at least one shank groove of a tool shank inserted into the tool receiving bore when the locking pin is in the first position.

The problem of the present disclosure is also solved by a tool holder for clamping tools, in particular tools for machining workpieces with rotating tools, which has a clamping component including: a base body, which has an outer surface and a cylindrical tool receiving bore, arranged concentrically to the outer surface, with a locking pin bore, which is arranges tangentially in the base body and defined an overlapping area by overlapping with the tool receiving bore, a moveable locking pin, with a first end and a second end and a tool retaining area, arranged between the first end and the second end, wherein a first position of the locking pin, defined by a first stop means, the tool retaining area is arranged in the overlapping area, wherein the locking pin is held at both ends within the locking pin bore of the clamping component on both sides of the overlapping area, and wherein, in a second position of the locking pin, defined by a second stop means, the first end is arranged outside and the second end is arranged at least partially inside the locking pin bore of the clamping component, but outside of the overlapping area.

The toolholder according to the present disclosure for clamping tools, in particular tools for machining workpieces with rotating tools, which has a clamping component according to the above type.

Both features and advantages described in relation to the clamping component according to the present disclosure are also applicable to the toolholder according to the present disclosure.

### BRIEF DESCRIPTION OF THE DRAWINGS

Further details of advantageous further embodiments or details of the present disclosure can be gathered from the drawings, the description and the claims. The following is illustrated in the figures:

FIG. 1 A cross-section of a clamping component according to a first embodiment example with a locking pin located in the second position;

FIG. 2 A cross-section of the clamping component according to the first embodiment example of the clamping component, in which the locking pin is in the first position;

FIG. 3 A schematic longitudinal section of the clamping component according to the first embodiment example;

FIG. 4 A cross-section of the clamping component according to a second embodiment example with a locking pin located in the second position;

FIG. 5 A cross-section of the clamping component according to the second embodiment example of the clamping component, in which locking pin is in the first position;

FIG. 6 A schematic longitudinal section of the clamping component according to the second embodiment example;

FIG. 7 A cross-section of a clamping component according to a third embodiment example with a locking pin located in the second position;

FIG. 8 A cross-section of the collet chuck according to the third embodiment. example of the clamping component, in which the locking pin is located in the first position;

FIG. 9 A schematic longitudinal section of the clamping component according to the third embodiment example;

FIG. 10 A cross-section of a clamping component according to a fourth embodiment example with a locking pin located in the second position;

FIG. 11 A cross-section of the clamping component according to the fourth embodiment example of the collet, in which the locking pin is in the first position;

FIG. 12 A schematic longitudinal section of the collet according to the fourth embodiment example;

FIG. 13 A schematic longitudinal section of a toolholder with a collet chuck arranged therein;

FIG. 14 A schematic longitudinal section of a toolholder with a clamping sleeve arranged therein.

### DETAILED DESCRIPTION

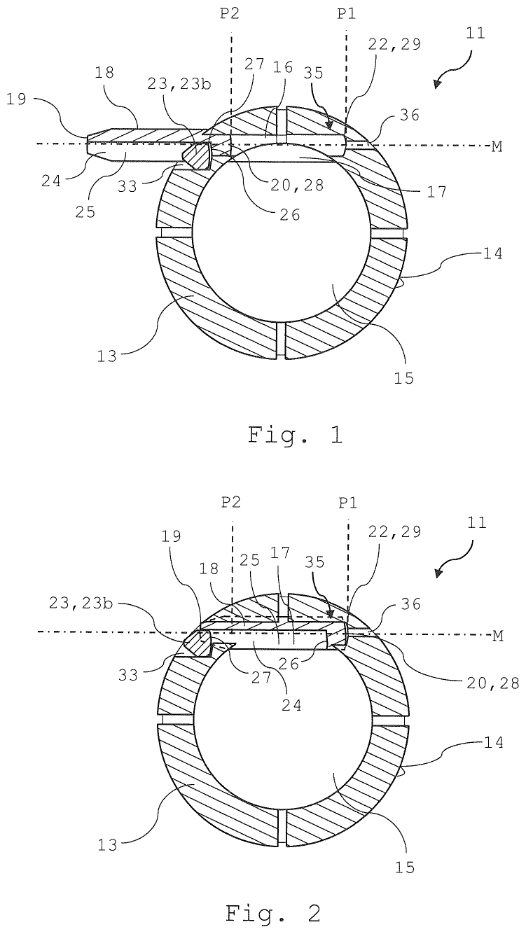

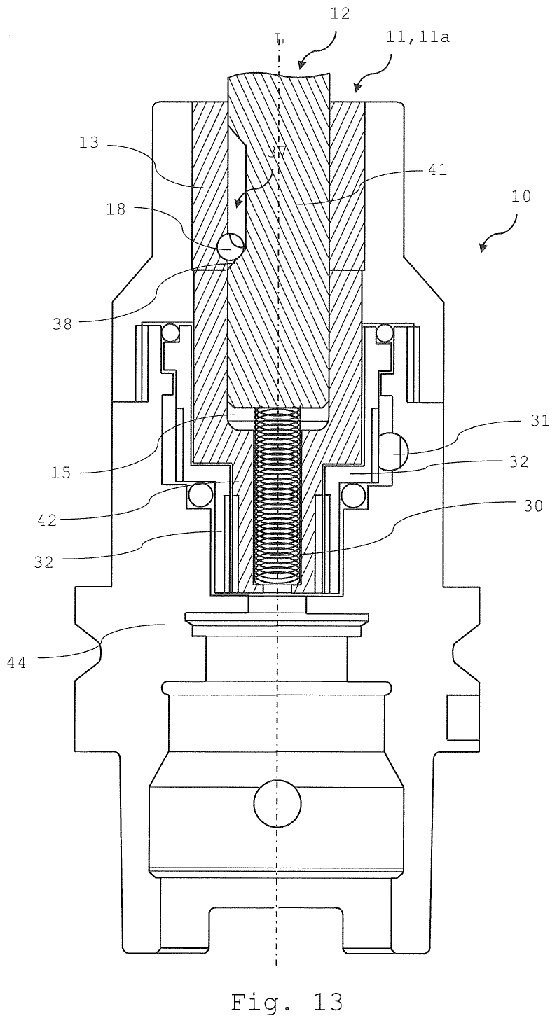

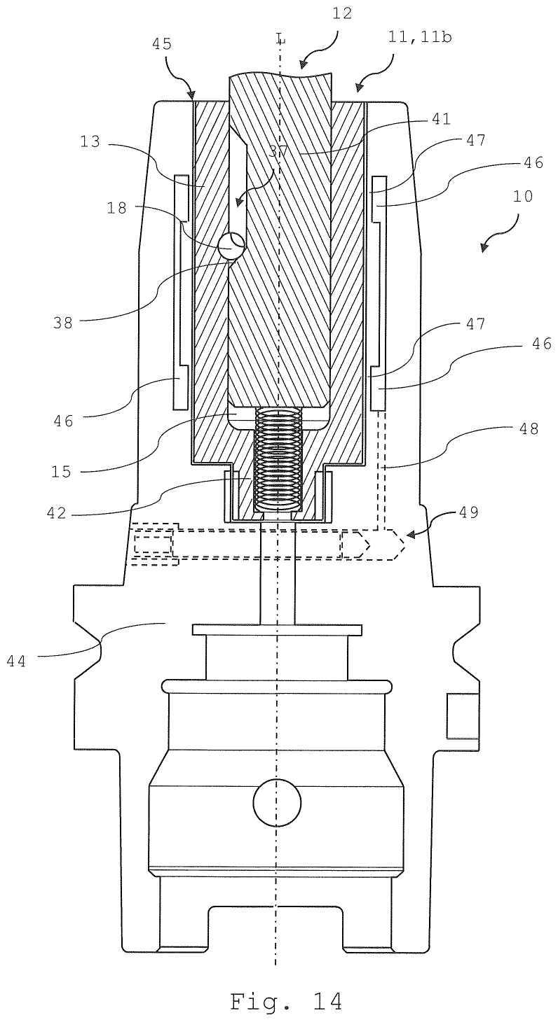

In the embodiment examples illustrated in FIGS. 1 to 12, the clamping component 11 is shown as a collet chuck 11a by way of example. FIG. 13 shows a corresponding embodiment example of a toolholder 10 with a collet chuck 11a arranged therein. FIG. 14 shows in an embodiment example of a toolholder 10 in which a clamping component 11 is configured as a clamping sleeve 11b.

FIG. 1 shows a cross-section of a clamping component 11 according to a first embodiment example.

The clamping component 11 is configured as a collet chuck 11a and has a base body 13 with a conical outer surface 14. In this example, the base body is interrupted by four slots. Concentric to the outer surface 14, the base body 13 has a cylindrical tool receiving bore 15, into which a tool, in particular, a tool for machining workpieces with rotating tools, can be received.

A locking pin bore 16 is formed in the base body, which is arranged in the base body 13 tangentially to the tool receiving bore 15, i.e., a central axis M defined by the locking pin bore 16 extends at least substantially tangentially to the tool receiving bore 15.

The locking pin bore 16 intersects the tools receiving bore 15 and thereby forms and overlapping area 17. A locking pin 18 is arranged in FIG. 1 and a second position P2, in which the locking pin 18 is arranged partly inside and partly outside the locking pin bore 16.

The locking pin 18 has a first end region 19 which, in the second position, P2 tool of the locking pin 18, is arranged outside the locking pin bore 16 in a clamping component 11. The locking pin 18 also has a second end portion 20, which is arranged in the second position P2 inside the locking pin bore 16.

In this position, the second end region 20 of the locking pin 18 is arranged outside the overlapping area 17. The overlapping area 17 is free, so that in this position P2 a shank 41 of a tool 12 can be inserted into the tool receiving bore 15.

In this embodiment example, the locking pin 18 has a concave recess 25, which extends from the first end 19 of the locking pin 18 along the center axis M of the locking pin 18 to a first stop surface 26. First stop surface, 26 is arranged at the least substantially orthogonal to the bottom surface 24 of the recess 25.

The locking pin bore 16 has a first stop means 22 and an end region 35. In his example, the first stop means 22 is formed as fourth stop surface 29. The second end 20 of the locking pin 18 has third stop surface 28. In the second position P2 of the locking pin 18, the third stop surface 28 is not in contact with the fourth stop surface 29.

The clamping component 11 illustrated in FIG. 1 also has a second stop means 23, which is configured as a locking pin 23b in this example. The locking pin 23b is arranged in a stop means opening 33. For example, the locking pin 23b can be pressed and/or glued into the stop means opening 33.

The recess 25 has a concave surface 24, the coverage of which is adapted to the second stop means 23, i.e. to the locking pin 23b, so that the first end 19 and the tool retaining area 21 of the locking pin 18 can be moved past the second stop means 23. The second stop means 23 has a second stop surface 27 on a side facing the first stop surface. 26 of the locking pin 18. In the second position, P2 of the locking pin 18, the first stop surface 26 of the locking pin 18 is in contact with the second stop surface 27 of the second stop means 23.

In addition, the clamping component 11 has an end section bore 36, which is adjacent to the end region 35 of the locking pin bore 16. With the appropriate tool fitted to the pushout bore 36, the locking pin 18 can thus be removed through the pushout bore 36, for example, into the second position, or into any position arranged between the first position P1 and the second position P2. The movement stroke of the locking pin 18 is thus limited by the second stop means 23 in the extension direction of the locking pin 18.

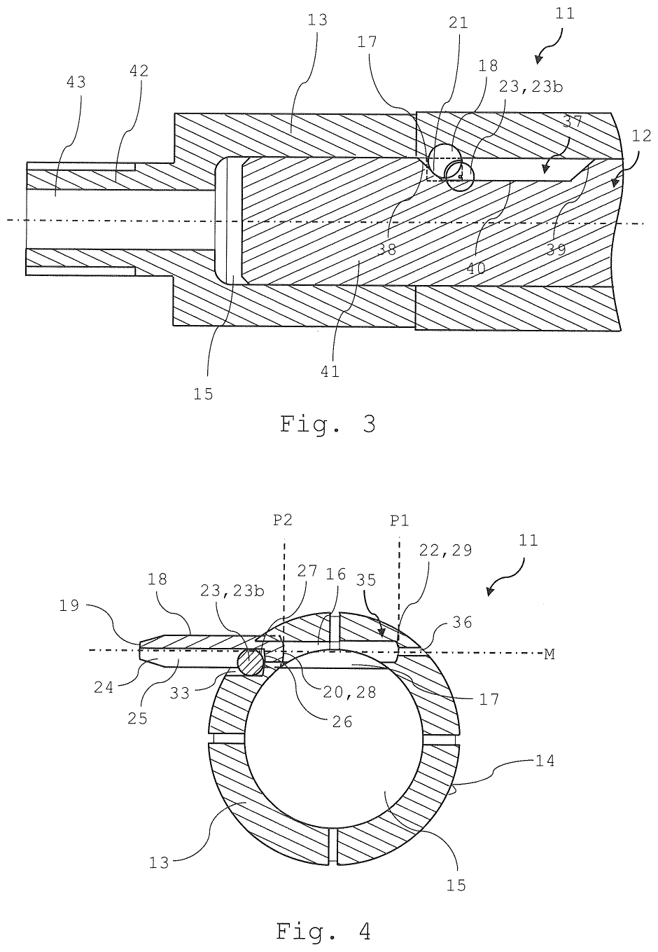

FIG. 2 shows the first embodiment example from FIG. 1, wherein the locking pin 18 is in a first position P1. In this position P1, the third stop surface is in contact with the fourth stop surface 29.

The movements stroke of the locking pin 18 is thus limited in the insertion direction of the locking pin 18, by the first stop means 22. The first stop means 22 is also did configured here as fourth stop surface 29.

FIG. 3 shows a longitudinal section of the first embodiment example (see FIGS. 1 and 2). In FIG. 3 the shank 41 of a tool 12 is arranged in the tool receiving bore 15 of the base body 13 of the clamping component 11. The shank 41 of the tool 12 has a groove 37, which is provided with a first inclined wall 38, a second inclined wall 39, and a bottom surface 40 connecting the two walls 38, 39.

The locking pin 18 intersects the tool receiving bore 15 in the overlapping area 17 when it is inserted into the locking pin bore 15 to the first position P1. In the overlapping area 17, the tool retaining area of the locking pin 18 arrests against the first inclined wall 38 of the groove 37 of the tool 12. For better illustration, FIG. 3 also shows second stop means 23, which in a first embodiment example is configured as a locking pin 23b and which is actually arranged above the cutting plane of the longitudinal section.

The clamping component 11 also has a clamping stud 42 with an external threat on a side facing away from the tool receiving bore 15. A fluid channel 43 is provided in the clamping stud 42, which opens into the tool holding ball.

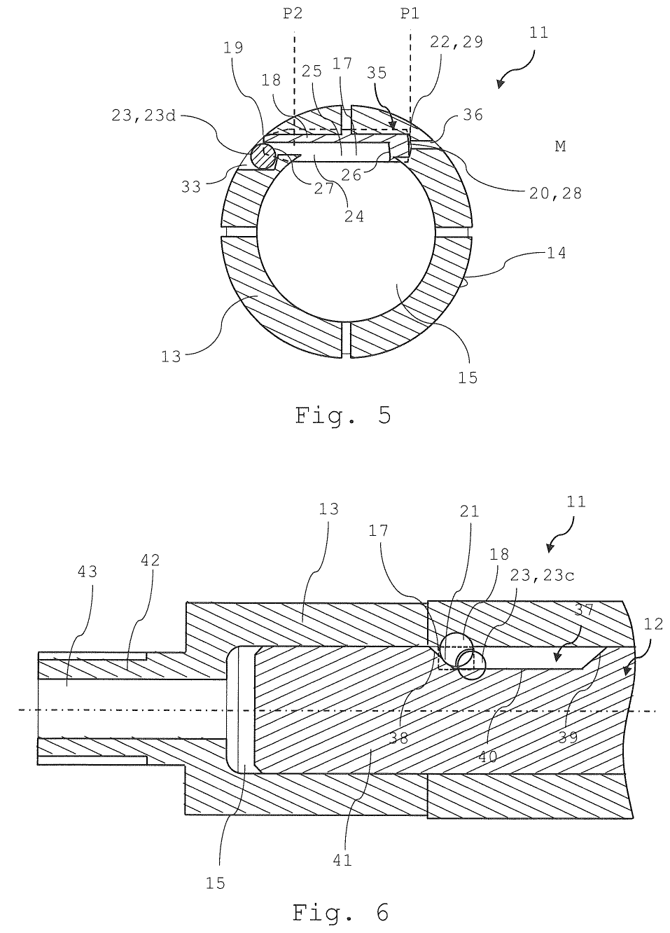

FIG. 4 shows a cross-section of the clamping component 11 according to a second embodiment example. The previous description applies accordingly to the second embodiment example, based on the reference signs already introduced. In addition, the following applies: the second embodiment example, differs from the first embodiment example, and that the second stop means 23 is configured as a stop ball 23d. The first stop surface 26, which is arranged on a side of the recess 25 of the locking pin 18 facing the first end 19, is adapted to the second stop surface 27 of the stop ball 23d, so that the first stop surface 26 bears against the second stop surface 27 and the second position P2.

FIG. 5 shows the second embodiment example (see FIG. 4), wherein the locking pin 18 is in the first position P1. In this position, the third stop surface 28 of the locking pin 18 is in contact with the fourth stop surface 29 of the first stop means 22.

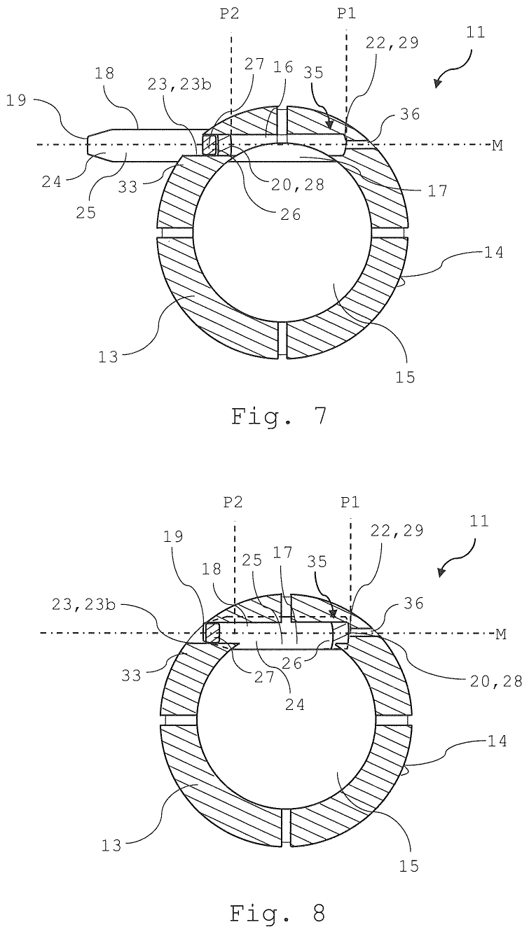

FIG. 6 shows a schematic longitudinal section of the second embodiment example (see FIGS. 4 and 5). Here too, the tool retaining area 21 of the locking pin 18 is in contact with the first inclined wall 38 of the groove 37 of the tool 12. FIG. 6 also shows the second stop means 23, which in the second embodiment example is formed as a stop ball 23d, and which is actually arranged above the sectional plane of the longitudinal section.

FIG. 7 shows a clamping component 11 according to a third embodiment example, wherein the locking pin 18 is arranged in a second position, P2. In the third embodiment example, similar elements of the clamping component are denoted with the same referenced signs as in the first and second embodiment example.

The embodiment example shown in FIG. 7 differs from the first and second embodiment examples (see FIGS. 1 to 6) and that the second stop means 23 is formed by a feather key 23a. A second stop surface. 27 is formed on the feather key 23a, which bears against the first stop surface 26 of the locking pin 18 when the locking pin 18 is arranged in the second position P2. In the third embodiment example, the locking pin 18 has a recess 25, which is formed along the center axis M of the locking pin from the first end 19 of the locking pin 18 to the second stop surface 26 of the locking pin 18. The recess 25 covers the entire width of the locking pin 18 in the orthogonal direction to the center axis M of the locking pin 18.

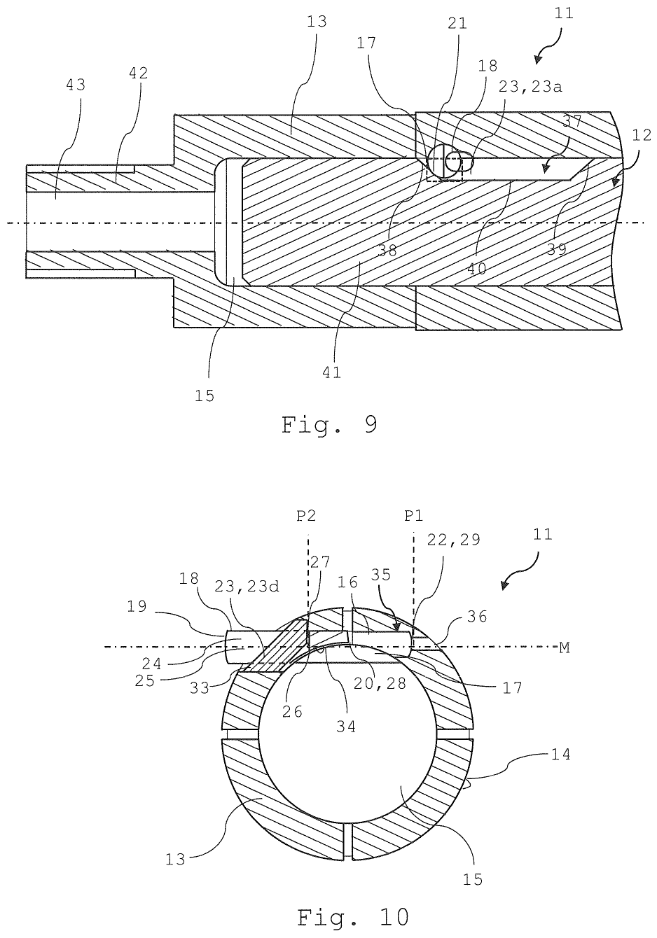

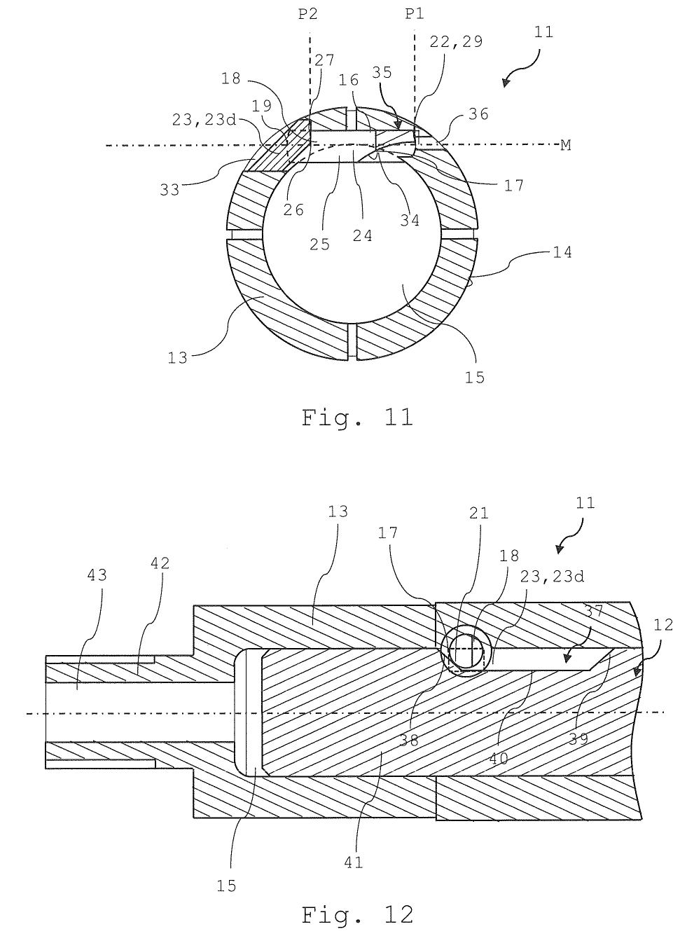

FIG. 8 shows the third embodiment example of the clamping component 11 (see FIG. 7), wherein the locking pin 18 is arranged in the first position P1. FIG. 9 shows a schematic longitudinal section of the third embodiment example (see FIGS. 7 and 8). FIG. 9 also shows the second stop means 23, which in the third embodiment example is designed as a locking pin 23a and which is actually arranged above the sectional plane of the longitudinal section.

FIG. 10 shows a fourth embodiment example of the clamping component 11 in a cross-section. In the fourth embodiment example, the same elements of the clamping component 11 are designated with the same referenced signs as in the first embodiment example, whereby the fourth embodiment example differs from the preceding embodiment examples, in that the second stop means 23 is configured as a slotted link 23c. The slotted link 23c can, for example, be glued into the stop means receiving opening 33. The slotted link 27c has an opening through which the part of the locking pin 18 provided with the recess 25 can be pushed. In the second position P2 of the locking pin 18, the first stop surface 26 of the locking pin 18 is in contact with the second stop surface 27 of the slotted link 23c. In addition, in the fourth embodiment example, the locking pin 18 has a convex surface 34, which is adapted to the inner diameter of the tool receiving bore 15 and, in the second position, fits, preferably steplessly, against the inner wall of the tool receiving bore 15. The overlapping area 17 thus remains free to move when the locking pin 18 is arranged in a second position P2.

FIG. 11 shows the fourth embodiment example (see FIG. 10), wherein the locking pin 18 is arranged in the first position P1. In the first position P1, the third stop surface 28 arranged at second and 20 of the locking pin 18 is arranged in contact with the fourth stop surface 29 of the first stop means 22.

FIG. 12 shows a schematic longitudinal section of the fourth embodiment example (see FIGS. 10 and 11). FIG. 12 shows the second stop means 23, which in the fourth embodiment example is configured as a slotted link 23d and which is actually arranged above the sectional plane of the longitudinal section.

FIG. 13 shows an embodiment example of a toolholder 10 with a clamping component 11. In this embodiment example, the clamping component 11 is a collet chuck 11a. The tool holder 10 has a clamping rotor 32, which is provided with an internal threat that engages with the external threat of a clamping start 42 of the collet chuck 11a. The clamping start 42 has a diameter that is smaller than the diameter of the collet chuck 11a to be measured at the end of its conical section. The clamping rotor 32 is rotably mounted within the toolholder 10 about a longitudinal axis L of the toolholder 10 and also has a toothing on its outer circumference which engages with a worm screw 31. The worm screw 31 is rotatably mounted in a base body 44 of the tool holder 10 about an axis of rotation oriented transversely to the longitudinal axis L of the toolholder 10 and is accessible from the outside. The screw 31 can be rotated by a tool.

FIG. 14 shows a further embodiment example of the toolholder 10 with a clamping component 11. In this embodiment example, the toolholder 10 has a hydraulic chuck. In this embodiment example, the clamping component 11 is configured as a clamping sleeve 11b. For this embodiment example, the previous description applies accordingly based on the referenced signs already introduced. The following additionally applies:

The toolholder 10 has a clamping sleeve 11b instead of a collet chuck 11a. The clamping sleeve 11b is inserted into a receiving means 45 of the toolholder 10 and is circumferentially surrounded by a pressure chamber 46, wherein an elastic thin wall 47 is formed between the receiving means 45 and the pressure chamber 46. The pressure chamber 46 is filled with a hydraulic medium, such as oil, and is connected to a hydraulic medium source 49 via a channel of 48 formed in the toolholder 10. Hydraulic fluids can be applied to the pressure chamber 46 via the hydraulic fluid source 49, so that the thin-walled wall 47 of the holder 45 in the area of the pressure chamber 46 forms elastically regularly inwards. The deformation of the wall 47 leads to a pressure acting radially inwards on the clamping sleeve 11b arranged in the holder 45, which in turn transmits the pressure to a tool shank 41 inserted in the receiving bore 15 of the clamping sleeve 11b. This claims the tool shank 41 in the clamping sleeve 11b. The hydraulic fluid source 49 and the channel 48 are illustrated with a dashed line, as this is arranged below to sectional plane shown in FIG. 14.

The toolholder 10 with the clamping component 11 described in this respect is used to replace round shanks with a shank groove 37 of tools 12 as follows:

The clamping component is disassembled from the toolholder 10. In the embodiment example shown in FIG. 13, this assembly can be performed by rotating the clamping rotor 30 against the clamping direction until the external threat of the clamping stud 42 is no longer in engagement with the internal threat of the clamping rotor 30. In the embodiment example shown in FIG. 14, the toolholder 10 is this disassembled by adjusting the hydraulic fluid source 49, so that the pressure chamber 46 is not under pressure. As a result, the elastic wall 48 of the pressure chamber 46 does not deform radially inwards. The clamping sleeve 11b can now be unscrewed from the receiving means 45 and the toolholder 10 until the external threat of the clamping stud 42 is no longer engaged with the internal threat of the toolholder 10. The clamping component 11, i.e. the collet chuck 11a or the clamping sleeve 11b, can now be removed from the toolholder 10.

The locking pin 18 further prevents the tool shank 41 of the tool 12 from being pulled out of the tool receiving bore 15 of the clamping component 11. The locking pin 18 is located in the first position P1, in which the tool retaining area 21 of the locking pin 18 in the overlapping area 17 rests against the first wall 38 of the shank groove 37 of the tool shank 41. The clamping component 11 also has a length stop element 30 which represents a length stop in the insertion direction for the tool shank 41. The length stop element 30 can also be configured as a spring element 30, for example, which applies a force against the tool shank 41 so that the first wall 38 of the shank groove 37 is pressed against the tool retaining area 21 of the locking pin 18.

The locking pin 18 can now be pushed of the locking pin bore 16 using a tool that is appropriately adapted to the pushout bore 36 until the locking pin 18 abuts against the second stop means 23 and the second position P2. In this second position P2, the locking pin 18 clears the overlapping area 17 in the tool receiving bore 15 so that the tool 12 can be removed from the tool receiving bore 15. Another tool 12 can now be inserted into the tool receiving bore 15 of the clamping component 11. The locking pin 18 is now moved from the second position P2 to the first position P1, in which the locking pin is fully positioned in the locking pin bore 16. In the first position P1, the third stop surfaced 28 of the locking pin 18 is in contact with the fourth stop surfaced 29 of the locking pin bore 29. The overlapping area 17 and the tool receiving bore 15 is blocked by the locking pin 18 in such a way, that the tool retaining area 21 of the locking pin 18 rests against the first wall 38 of the shank groove. 37 of the other tool 12. The clamping component 11 is then inserted into the toolholder 10. In the embodiment example shown in FIG. 13, the screw 31 is now tightened in the clamping direction. In the embodiment example shown in FIG. 14, the pressure chamber 46 is correspondingly pressurized with hydraulic fluid via the hydraulic fluid source 49.

The clamping component according to the present disclosure has a locking pin movable between the first and the second position, which is provided with a tool retaining area formed between the ends of the locking pin. In the first position, the tool retaining area protrudes into a tool receiving bore of the clamping component, while in the second position, the locking pin does not protrude into the tool receiving bore. The locking pin is always attached to the clamping component in both the first and the second position, which makes the improved withdrawal protection particularly easy to use and ensures that it cannot be lost. The locking pin can be moved (steplessly) between the first and second position, whereby the tool retaining area of the locking pin in the first position prevents the tool from being drawn out of and rotated out of the tool receiving bore.

### REFERENCE SIGNS

10 Tool holder
11 clamping component
11a collet chuck
11b clamping sleeve
12 tool
13 base body
14 outer surface of the base body
15 tool receiving bore
16 locking pin bore
17 overlapping area
18 locking pin
19 first end of the locking pin
20 second end of the locking pin
21 tool retaining area
22 first stop means
23 second stop means
23a feather key
23b securing pin
23c slotted link
23d stop ball
24 surface of the recess
25 recess of the locking pin
26 first stop surface
27 second stop surface
28 third stop surface
29 fourth stop surface
30 length stop surface (spring elements)
31 worm screw
32 clamping rotor
33 stop means
34 convex surface at the second end of the locking pin
35 end area of the locking pin bore
36 pushout bore
37 shank groove
38 first wall of the shank groove
39 second wall of the shank groove
40 bottom surface of the shank groove
41 tool shank (shank)
42 clamping stud
43 fluid channel
44 base body of the tool holder
45 tool holder mount for the clamping sleeve
46 pressure chamber
47 wall
48 channel
49 hydraulic fluid source
L longitudinal axis of the tool holder
M center axis
P1 first position of the locking pin
P2 second position of the locking pin

1. A clamping component for a tool holder for clamping tools, preferably tools for machining workpieces with rotating tools, comprising:
a base body, which has an outer surface and a cylindrical tool receiving bore, arranged concentrically to the outer surface,
with a locking pin bore, which is arranges tangentially in the base body and defined an overlapping area by overlapping with the tool receiving bore, a moveable locking pin, with a first end and a second end and a tool retaining area, arranged between the first end and the second end,
wherein a first position of the locking pin, defined by a first stop means, the tool retaining area is arranged in the overlapping area,
wherein the locking pin is held at both ends within the locking pin bore of the clamping component on both sides of the overlapping area, and
wherein, in a second position of the locking pin, defined by a second stop means, the first end is arranged outside and the second end is arranged at least partially inside the locking pin bore of the clamping component, but outside of the overlapping area.

2. The clamping component according to claim 1, wherein the locking pin has a recess along a central axis of the locking pin, which defines at least one surface past which the second stop means slides when the locking pin moves.

3. The clamping component according to claim 2, wherein the at least one surface of the recess is a flat surface which extends parallel to the central axis of the locking pin.

4. The clamping component according to claim 2, wherein the recess has a convexly shaped surface which extends parallel to the central axis of the locking pin, wherein the convexly shaped surface is preferably adapted to a concavely shaped surface of the second stop means.

5. The clamping component according to claim 2, wherein the recess of the locking pin is arranged on a side of the locking pin facing away from the tool retaining area.

6. The clamping component according to claim 2, wherein the recess extends from the first end of the locking pin to a first stop surface formed in the locking pin, the first stop surface, preferably being arranged at least substantially orthogonally to the central axis of the locking pin.

7. The clamping component according to claim 6, wherein the first stop surface bears against a second stop surface of the second stop means when the locking pin is in the second position.

8. The clamping component according to claim 1, wherein a third stop surface is formed at the second end of the locking pin and bears against the first stop means, when the locking pin is in the first position.

9. The clamping component according to claim 1, wherein the first stop means is a fourth stop surface, which is formed in an end region of the locking pin bore and against which the second end of the locking pin bears when the locking pin is in the first position.

10. The clamping component according to claim 1, wherein the locking pin bore is adjoined by a pushout bore, through which the locking pin is ejectable.

11. The clamping component according to claim 1, wherein the second stop means is pressed and/or glued into a stop means opening which is adapted to the second stop means in the base body of the clamping component.

12. The clamping component according to claim 1, wherein the second stop means is formed as one of the following elements: a feather key, a locking pin, a slotted link, or a stop ball.

13. The clamping component according to claim 1, wherein the locking pin has a convex surface at the second end which is adapted to the a curvature of the an inner wall of the tool receiving bore.

14. The clamping component according to claim 1, wherein the tool retaining area of the locking pin is engageable in the overlapping area with a shank groove of a tool shank of a tool inserted into the tool receiving bore, when the locking pin is in the first position.

15. A tool holder for clamping tools, in particular tools for machining workpieces with rotating tools, which has a clamping component comprising: a base body, which has an outer surface and a cylindrical tool receiving bore, arranged concentrically to the outer surface, with a locking pin bore, which is arranges tangentially in the base body and defined an overlapping area by overlapping with the tool receiving bore, a moveable locking pin, with a first end and a second end and a tool retaining area, arranged between the first end and the second end, wherein a first position of the locking pin, defined by a first stop means, the tool retaining area is arranged in the overlapping area, wherein the locking pin is held at both ends within the locking pin bore of the clamping component on both sides of the overlapping area, and wherein, in a second position of the locking pin, defined by a second stop means, the first end is arranged outside and the second end is arranged at least partially inside the locking pin bore of the clamping component, but outside of the overlapping area.

16. The clamping component according to claim 3, wherein the recess has a convexly shaped surface which extends parallel to the central axis of the locking pin, wherein the convexly shaped surface is preferably adapted to a concavely shaped surface of the second stop means.

17. The clamping component according to claim 16, wherein the recess of the locking pin is arranged on a side of the locking pin facing away from the tool retaining area.

18. The clamping component according to claim 17, wherein the recess extends from the first end of the locking pin to a first stop surface formed in the locking pin, the first stop surface, preferably being arranged at least substantially orthogonally to the central axis of the locking pin.

19. The clamping component according to claim 18, wherein the first stop surface bears against a second stop surface of the second stop means when the locking pin is in the second position.

20. The clamping component according to claim 19, wherein a third stop surface is formed at the second end of the locking pin and bears against the first stop means, when the locking pin is in the first position.
